(19) United States
(12) Patent Application Publication
(10) Pub. No.: US 2006/0126106 A1
(43) Pub. Date: Jun. 15, 2006

(54) System and method for remote proof printing and verification

(75) Inventor: Steven J. Harrington, Webster, NY (US)

Correspondence Address: BASCH & NICKERSON LLP, 1777 PENFIELD ROAD, PENFIELD, NY, 14526, US

(73) Assignee: Xerox Corporation

(21) Appl. No.: 11/009,875

(22) Filed: Dec. 10, 2004

(51) Int. Cl. G06F 3/12

(52) U.S. Cl. 358/1.15; 358/504

(57) ABSTRACT

The present disclosure is directed to a system and method to enable a remote proof printer, wherein a remote proof print may be produced, checked and verified before being provided to a customer for review. The remote proof printer verification step includes scanning or digitizing the proof document and comparing it to the image data to determine if the proof document is suitable for user review.

Provided is a system and method for remote proof printing, and more particularly remote proof printing with verification by scanning or digitizing the proof document and comparing it to the image data to determine if the proof document is suitable for customer review.

### BACKGROUND AND SUMMARY

The following patents or publications are noted as teaching aspects of remote proofing, and are hereby incorporated by reference in their entirety:

U.S. Pat. No. 6,607,258 to R. Jodra et al. discloses converting a content provider's original data file to a different color space to form a proofing data file. A proofing facility, which is distinct from the target facility, uses the proofing file to produce a visible proof for viewing by the content provider, customer etc.

U.S. Pat. No. 6,381,343 to Davis et al. and US 2003/0007191 to F. Herbert describe press proofing systems and methods wherein color image files may be reviewed at remote locations, wherein the color image files are produced as a result of a digitization operation of a proof print. In an alternative embodiment, the color image files are shared directly, prior to printing, and may be adjusted to as to enable accurate rendering by a gamut-limited printing device (FIG. 5).

Although several patents characterize a general problem associated with customer inspection of pre-production proofs of print documnents—timely review of proof documents from remote locations—it is not believed that such patents and publications handle the requirement of verifying the acceptability of a proof print prior to “releasing” the proof to the customer for review. Accordingly, the following disclosure sets forth a system and method to enable a printing operation to control a remote proofing printer.

One aspect is based on the observation of problems with conventional proofing operations. Not only the problem of distance and time of the customer causing a delay in the proofing process, but also the problem of having feedback and control of what a remote customer might be viewing as a proof copy. This aspect is based on the discovery of a technique that alleviates these problems by providing a remote proofing printer, wherein the operation, setup and printing may be controlled by the production printer, and where a proof sheet is scanned and compared or confirmed prior to being provided to the customer for review.

Disclosed in embodiments herein is a method for remotely generating a hardcopy proof of a digital image to be printed, comprising the steps of: receiving, at a location remote from a print production server, an image data file; printing the image data file on a proof printer at the remote location to produce a hardcopy document; scanning the hardcopy document, at the remote location, to create a digitized image file; and comparing the digitized image file to the image data file to determine if the hardcopy document is an acceptable proof document.

Further disclosed in embodiments herein is a system for remote proof printing, comprising: a print production server; a communication network; a remote proof printer, said proof printer being in electronic communication with said print production server through said communication network, said proof printer having a printing engine; an image data file, sent from said print production server to said remote proof printer for printing a proof output; said remote proof printer further including an associated hardcopy digitization subsystem suitable for scanning the proof output and creating a digitized image file representative thereof; and a comparator for comparing the digitized image file to the image data file to verify that the proof output is an acceptable proof document.

### BRIEF DESCRIPTION OF THE DRAWINGS

FIG. 1 is a detailed flow diagram depicting various process steps associated with a method for carrying out remote proof printing with verification; and

FIG. 2 is a block diagram illustrating an embodiment of a system for remote proof printing.

The system and method will be described in connection with a preferred embodiment, however, it will be understood that there is no intent to limit them to the embodiment described. On the contrary, the intent is to cover all alternatives, modifications, and equivalents as may be included within the spirit and scope of the appended claims.

### DETAILED DESCRIPTION

For a general understanding of the system and method, reference is made to the drawings. In the drawings, like reference numerals have been used throughout to designate identical elements.

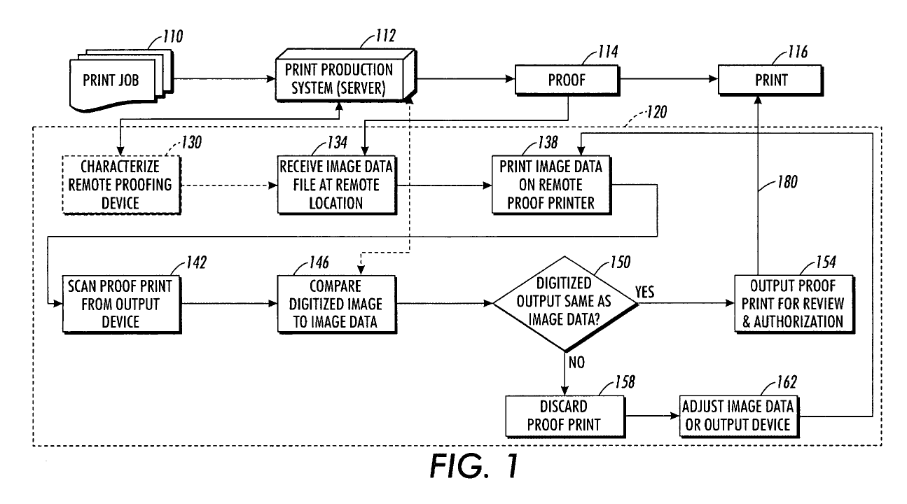

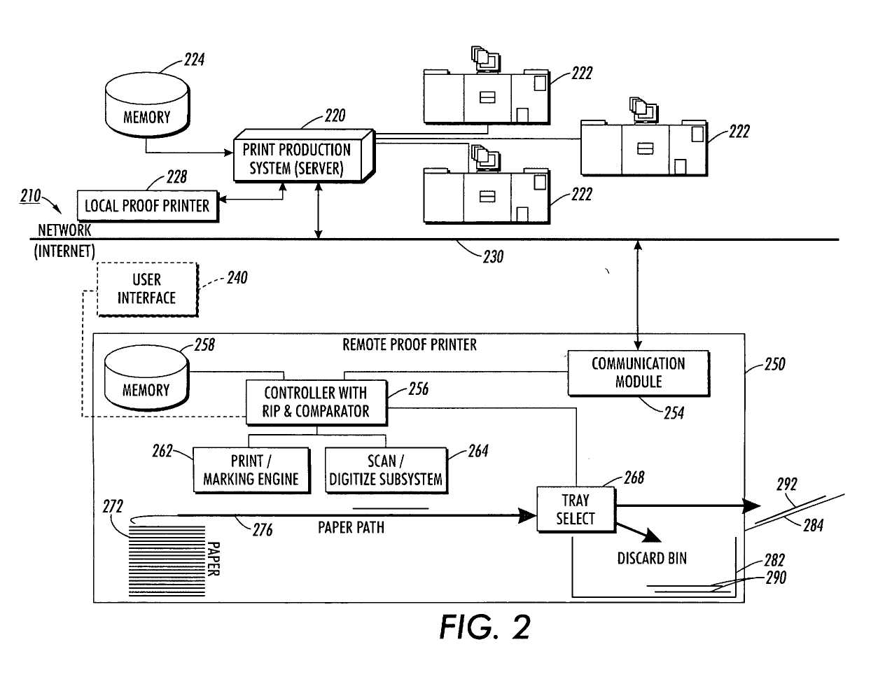

Referring to FIG. 1, there is depicted an exemplary method 120 for remotely generating a hardcopy proof of a digital image to be printed. Such a process may be initiated, for example, by a commercial printer in response to the receipt of a print job or similar printing request represented by reference numeral 110. In some cases, the print job may be stored in a memory (224 in FIG. 2) associated with a print production system or server 112. The print production system may be any suitable computer-based workstation or the like running a Microsoft® Windows, Unix or similar operating system, and configured with well-know print workflow management software such as Xerox® Enterprise Resource Planning (ERP) Printing Solutions, including SAP/R3 compatible systems that manage business processes. It will be appreciated that such a system would preferably be suitable to interface with and support production printing on equipment such as the Xerox® iGen3™ and/or DocuColor™ production presses.

As noted above, it is common practice, particularly in production printing environments, to produce a proof copy (step 114) of the intended output for customer review and approval prior to actually completing the production printing of the job (step 116). By having a customer review and approve a proof print, the risk of printing an entire job only to have it rejected by the customer is reduced. However, the ability to have a proof copy reviewed and approved by a remote customer is often difficult, and at a minimum is likely to add delay in the printing process of steps 110-116.

Accordingly, one embodiment of method 120 for remotely generating a hardcopy proof contemplates the print production system creating a proof image as in step 114, but rather than printing the image, the system sends the image to a remote proof printer, where it is received as an image data file as indicated by step 134. At the remote location the remote proof printer then prints the image data file on an output device at the remote location to produce a hardcopy document at step 138. However, the production printer also wants to avoid problems by a customer rejecting or accepting the proof copy based upon an erroneous proof generated by the remote proof printer. Thus, the method further includes step 142 for scanning the hardcopy proof document, at the remote location, to create a digitized image file, and then comparing the digitized image file to the image data file at step 146, to determine if the hardcopy document is an acceptable proof document. As represented by test step 150, the comparison is conducted to determine if the digitized output image is essentially the same as the image data file received. Based upon the result of the comparison, the proof copy is either output for review by the customer, step 154, or it is discarded, step 158, and the image data or printer is adjusted, step 162, before the process is restarted at step 138. By scanning the proof copy and comparing it, the method assures that the proof copy being reviewed is essentially equivalent to a proof that would be created at the production facility. Moreover, the method allows a customer to hold and feel the proof copy.

Although in a “theoretical” approach, the comparison of step 146 seems straightforward, it is practically impossible to compare raw image data (pre or post rip) with the scanned data. For other than grossly over-simplified documents (e.g., blank pages, low content black/white pages), there simply would be very little likelihood of a direct match, even if the proof was completely accurate and true to coloration. Accordingly, an alternative to direct image data comparison is required to establish whether an acceptable proof copy has been printed. In one embodiment, the desired image values, or more generally, the information against which the digitized output image is to be compared or analyzed, would likely be provided from the Print Production System (Server) 112, and it will be appreciated that several alternative methods may be employed for such a comparison step.

One manner of producing the desired image values would be by printing and then scanning the image at the production site so as to generate a similar digitized image. The image could be printed at the press 222 of FIG. 2 (this could be done for a digital print, but for offset printing this would be unlikely because of the cost of setting up the press). As an alternative, the image could be printed at a similar or similarly-configured proof printer 228 (FIG. 2) at the production facility and scanned to create the digital image data to be compared with the customer's digitized output image. Once created, the comparison data would be transmitted from the print production system to the remote proof printer, and would be available for comparing one or more proof prints. In these embodiments, it would remain, of course, to compare the data and make sure that the remote proof matches the production facility proof. And, it would be incumbent on the press operator to make sure the press print matches the local proof print).

An alternative to actually printing and scanning the image at the production facility would be enabled by a good digital simulation model of the printing press. This would allow the ideal image values to be directly generated by the simulation rather than by an actual printing and scanning process. Desired image values could be generated at the production site, perhaps via software operating on the print production system (server), and sent to the remote proofing printing system. Such a possibility is also represented in FIG. 1 by the dashed line between step 146 and the print production system (server) 112. Alternatively, parameters for the simulation model could be sent to the remote proofing system and the remote system could use the simulation model and the image data file to generate the desired image values at the remote site.

Once the desired image values are made available to the remote proofing system, they can be used for a comparison against the scan of the actual proof print at steps 146 and 150. That comparison could be carried out by aligning the desired and scanned digital images and comparing color values on a pixel by pixel basis, or at least partially. An alternative method of comparison would be to construct histograms of color values for the desired and proof images and just compare the histograms. Although the histogram approach avoids the problem of aligning the images, it may be blind to some unlikely cases of mismatched images. In this regard, the process might also include printing and comparing certain test patterns, for example, as part of the characterization step 130. Furthermore, test patterns might be designed to make alignment easy and could be designed on a job-specific basis to include the colors of interest, but again this could be more risky than comparing the actual image to be printed.

Having described the general method of remote proof printing with verification, further details and alternatives to the above-described steps will now be discussed. Also illustrated in FIG. 2 is step 130 that reflects a characterization step for the remote proof printer. In such a step, the remote proof printer remotely performs characterization in response to an image data file received from the production print server. The image data file would include color patch information, and the characterization step would include generating at least one hardcopy characterization page based upon the image data file and color patch information. The hardcopy characterization page would then be scanned at the remote location to create a digitized characterization file. As will be appreciated, the hardcopy document produced during the characterization step would preferably be discarded in the same manner as unacceptable proof documents—preferably into a discard bin or similar structure as depicted in FIG. 2.

The digitized characterization file would be transmitted to the print production server for processing, and to identify any particular adjustments that would be required for that remote proof printer. It will be further appreciated that such adjustments may be accomplished by one of several approaches, including: (a) an automated adjustment process, where calibration parameters such as tonal reproduction curves, gamut corrections, etc. are transmitted or downloaded to the remote proof printer for loading and use; (b) a manual adjustment of the remote proof printer initiated by a determination that the characterization is out of a desired range; and/or (c) adjustment of image data files to be printed on the remote proof printer prior to sending them to the remote proof printer.

In one embodiment, it is contemplated that the method of FIG. 1 further includes sending the digitized image file, produced from scanning the proof copy, from the remote location to the print production server so that step 146 for comparing the digitized image file to the image data file may be carried out by the print production server. The dashed line between step 146 and system/server 112 is intended to represent such an information exchange. In this way, the comparison process may be performed by the production system, perhaps improving the speed of the process, or at least reducing the memory or processing power requirements of the remote proofing printer.

Also, as represented by line 180, the method contemplates a function on the remote proof printer (e.g., via a user interface) wherein the customer, upon review of the output proof copy at step 154, could send or signal the acceptance of the proof copy and authorize production of the job. In this way, the timely completion of the proofing operation could be completed and the production printing begun. In order to assure timely review of the proof copy, the method may further include signaling or message capability (via the remote proof printer or via the production system/server, that a proof copy is available for the customer's review at the remote proof printer.

In one embodiment, the printing is accomplished by a multifunction device employed as the remote proof printer, where the step of scanning the hardcopy document is also completed by the multifunction device. It will be understood that in the case of conventional multifunction devices, user intervention would be required to feed the proof copy document back through the device for digitization. In an embodiment where user intervention is not required, the device disclosed in FIG. 2 may be used, wherein the scanning of the hardcopy proof document occurs automatically in succession with its printing. While it is convenient to have the printing and scanning functions combined in the same physical device, this is not required, provided that the printing and scanning functions are logically integrated into the system.

Having described the method of remote proof printing with verification, attention is now turned to an exemplary system for carrying out the previously-described steps. More specifically, FIG. 2 depicts a system 210 for remote proof printing. One embodiment of the system includes a print production server 220 suitable for receiving, creating and storing, in memory 224, information relating to one or more print jobs. In normal operation, the server 220 operates to control work flow and communications with a plurality of production presses 222.

Server 220 is also preferably connected to a communication network 230, which may be a dedicated network or may be through or connected to the Internet. Also connected to the network 230, and in electronic communication with the production server, is a remote proof printer 250. The proof printer includes, in addition to an optional user interface 240, a communications module 254 for interfacing with the network and the production server, to receive data and instructions from the server and to send data and responses to the server.

The remote proof printer also includes a controller 256 or similar processing device suitable for receiving image data and processing it (e.g., a raster image processing (RIP)), along with a memory 258 for storing image data, as well as printer calibration and adjustment data, machine control instructions, etc. The remote proof printer further includes a print or marking engine 262 that is operated in response to signals from the controller 256 to produce hardcopy proofs on sheets of paper or similar substrate material 272 that travel along paper path 276. It will be appreciated that various marking engine technologies may be employed for print/marking engine 262 and the associated paper path. Such technologies may include, but are not limited to, electrostatic, ink jet, thermal ink and thermal transfer technologies, preferably technologies suitable for producing multi-color output.

Subsequent to printing of a proof copy, the scanning or digitizing subsystem 264 operates scan the proof output and create a digitized image file representative thereof. It will be appreciated that various techniques may be employed to scan or digitize the proof copy moving along paper path 276. In one embodiment, it is contemplated that the digitization occurs as the proof is moved relative to a fixed scanning bar or similar page-width device. In an alternative embodiment, the digitization may occur for the entire page using conventional 2-dimensional imaging chips such as those employed in digital cameras and the like. In either event, it will be appreciated that the resulting image data obtained from the scanning/digitizing operation will be returned to the controller 256 and possibly stored, at least temporarily in memory 258. Once the proof copy is digitized, its final destination is then determined as the result of a comparison operation to compare the digitized image data against the input image data file. Although it is possible that a separate comparator device be employed to conduct the comparison, it is also contemplated that such a process may be completed by the controller 256. As noted above, the comparator may actually be located or associated with the print production server, such that the digitized image data is transmitted to the server 220 for comparison and further action based upon the comparison.

Depending upon the output of the comparator (e.g., controller 256), a diverter or similar tray select device 268 either directs unacceptable proof copy 290 to discard bin 282 or directs acceptable proof copy 292 to output tray 284. As will be appreciated, discard bin 282 provides a subsystem for storage of unacceptable proof output.

An alternative to diverting unacceptable proof copies to a discard bin or tray would be to mark the copies as unacceptable in some way. One might, for example, print a rejection message on the reverse or back side of the print, Or one might print a cover page associated with the print that indicates its acceptance or rejection. One could also associate an identifier with each print, such as a print number, and produce a list of acceptable proof identifiers. One might also provide an indication of acceptability of the current print through some other user interface on the remote proofing device.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method for remotely generating a hardcopy proof of a digital image to be printed, comprising:
receiving, at a location remote from a print production server, an image data file;
printing the image data file on a proof printer at the remote location to produce a hardcopy document;
scanning the hardcopy document, at the remote location, to create a digitized image file; and
comparing the digitized image file to a comparison data file to determine if the hardcopy document is an acceptable proof document.

2. The method of claim 1, further comprising:
in response to the comparing step, outputting the hardcopy document in the event that the comparison indicates the document is acceptable; and
otherwise discarding the hardcopy document if unacceptable.

3. The method of claim 1, further comprising sending the digitized image file from the remote location to the print production server, and wherein the step of comparing the digitized image file to the comparison data file is carried out by the print production server.

4. The method of claim 1, further comprising sending the comparison data file from the print production server to the remote location, and wherein the step of comparing the digitized image file to the comparison data file is carried out at the remote location.

5. The method of claim 1, wherein the comparison data file is created by printing a local proof print at the production facility and digitizing the local proof print.

6. The method of claim 5, wherein the steps of printing a local proof print and digitizing the local proof print are accomplished using a local proof printer.

7. The method of claim 1, further comprising sending, from the remote location, an authorization to proceed with printing based upon the proof document.

8. The method of claim 1, wherein the printing is accomplished by a multifunction proofing device and where the step of scanning the hardcopy document is also completed by the multifunction proofing device.

9. The method of claim 8, wherein the scanning of the hardcopy document occurs automatically in succession with the printing of the document.

10. The method of claim 1, further comprising remotely performing characterization of the proof printer in response to an image data file including color patch information, wherein the characterization step includes generating at least one hardcopy characterization page based upon the image data file including color patch information, scanning the hardcopy characterization page, at the remote location, to create a digitized characterization file; and transmitting the characterization file to the print production server for processing.

11. The method of claim 10, further comprising automatically discarding the hardcopy document produced during said characterization step.

12. The method of claim 10, further comprising creating, in response to said characterization step, a plurality of calibration parameters, and downloading said calibration parameters to the proof printer.

13. The method of claim 1, wherein said comparison step includes creating histograms of both the comparison data file and the digitized image file, and comparing the histograms.

14. The method of claim 1, wherein said comparison step further includes:
aligning the comparison data file and the digitized image file; and
comparing at least a corresponding region of each file on a pixel by pixel basis.

15. A system for remote proof printing, comprising:
a print production server;
a communication network;
a remote proof printer, said proof printer being in electronic communication with said print production server through said communication network, said proof printer having a printing engine;
an image data file, sent from said print production server to said remote proof printer for printing a proof output;
said remote proof printer being operatively connected to an associated hardcopy digitization subsystem suitable for scanning the proof output and creating a digitized image file representative thereof; and
a comparator for comparing the digitized image file to a comparison data file to verify that the proof output is an acceptable proof document.

16. The system of claim 15, further comprising a subsystem for storage of unacceptable proof output.

17. The system of claim 15, wherein the digitized image file is transmitted to the print production server and where the comparator is located in the print production server.

18. The system of claim 15, further including system memory suitable for storing calibration data for use by said remote proof printer.

19. The system of claim 15, further including a local digitizing system to digitize a local proof print to generate the comparison data file.

20. The system of claim 19, wherein the local digitizing system is located within a local proof printing device.
